(19) United States
(12) Patent Application Publication
(10) Pub. No.: US 2026/0251399 A1
(43) Pub. Date: Aug. 27, 2026

(54) DEVICE FOR THERMAL REGULATION, IN PARTICULAR FOR COOLING

(71) Applicant: VALEO SYSTEMES THERMIQUES, Le Mesnil-Saint-Denis (FR)

(72) Inventors: Cedric De-Vaulx, Le Mesnil-Saint-Denis Cedex (FR); Kamel Azzouz, Le Mesnil-Saint-Denis Cedex (FR); Erwan Etienne, Le Mesnil-Saint-Denis Cedex (FR); Jean-Christophe Lhermitte, Le Mesnil-Saint-Denis Cedex (FR); Jeremy Blandin, Le Mesnil-Saint-Denis Cedex (FR)

(73) Assignee: VALEO SYSTEMES THERMIQUES, Le Mesnil-Saint-Denis (FR)

(21) Appl. No.: 18/881,991

(22) PCT Filed: Jul. 3, 2023
(86) PCT No.: PCT/EP2023/068239

§ 371 Date: Jan. 7, 2025

(30) Foreign Application Priority Data
Jul. 7, 2022 (FR) FR2206960

(51) Int. Cl. F28D 9/00; F28D 21/00; F28F 3/04

(52) U.S. Cl. CPC F28D 9/0068; F28F 3/044; F28D 2021/0029

(57) ABSTRACT

A device for thermal regulation, for a component prone to releasing heat during its operation, includes a circulation network for a heat transfer fluid. The circulation network includes at least one fluid mixing zone into which at least two separate fluid flows open at respective angles chosen so as to generate a mixture of a parietal layer of fluid and an internal layer of fluid in the mixing zone.

The present invention concerns a device for thermal regulation, in particular for cooling, in particular for an electrical component which can release heat during its operation, in particular a device for cooling at least one battery or battery cells of a vehicle, for example a motor vehicle.

The vehicle can be of the land, maritime or aerial type.

In particular, the invention concerns heat exchangers with plates which are designed for the circulation of a heat-transfer fluid, for example a coolant fluid or a glycoled water, permitting cooling of the batteries of hybrid or electric vehicles. The first plate, or upper plate, which comes into contact with the components to be called, is generally flat. The second plate, or lower plate, is a stamped plate in which circulation channels are formed for the heat-transfer fluid.

In a known manner, in order to increase the turbulence in the heat-transfer fluid, which turbulence has the effect of increasing the coefficient of exchange, and thus the thermal performance, two types of elements can be used.

Firstly, there are elements known as hard dimples which are bosses that form the connection between the lower plate and the upper plate. These bosses assure the mechanical connection of the assembly, while assuring a minimum level of disturbance of the cooling liquid. These bosses are strong from a mechanical point of view, but the thermal performance is not optimized. In fact, by passing through the entire height of the circulation channels, the bosses give rise to substantial losses of load, without however creating sufficient turbulence for the increase in the thermal performance to compensate for this loss of load.

There are also elements known as soft dimples which are bosses in the interior of the circulation channels, but have a lower height, such as to be recessed from the upper plate. These bosses do not participate in the mechanical strength of the cooling plates, but assure a substantial level of turbulence in the fluid. Patent application DE102014202161 describes bosses of this type.

The objective of the invention is to improve the homogeneousness of the temperature of the heat-transfer fluid circulating in the circulation network.

The invention thus proposes a device for thermal regulation, in particular for cooling, for a component which can release heat during its operation, in particular for an electrochemical energy storage module, this device comprising a circulation network for a heat-transfer fluid, this network comprising at least one area for mixing of fluid into which at least two separate streams of fluid open according to respective angles selected such as to generate a mixture of a parietal layer of fluid and an internal layer of fluid in the mixing area.

In the network for circulation of heat-transfer fluid, a parietal layer of fluid, which is on, or in the vicinity of, a heat-exchange wall, is heated more than an internal layer, which is further from this wall. The internal layer and the parietal layer extend one another more or less continuously in terms of temperature.

In the invention, the temperature gradient within a transverse cross-section of fluid is greater upstream from the mixing area, and smaller in the mixing area. The objective of the mixing is to attenuate, or even eliminate, this temperature gradient within the fluid.

The invention makes it possible to mix parietal layers of fluid and internal layers of fluid efficiently. The aforementioned angles are selected such that all the layers are mixed. An excessively small angle of incidence between the streams of fluid does not make it possible to mix the layers efficiently, since these flows would then be “too tangent” relative to one another.

The invention thus makes it possible to homogenize the temperature of the fluid over all of the transverse cross-section of the flow, i.e. on the wall and in the center of the stream. The fluid can thus have a lower temperature on the wall which acts as the thermal interface, such as to provide a better thermal exchange with the component to be cooled.

In the present invention, the mixing can take place at relatively low speeds of the fluid, which mixing is of a chaotic type thanks to the angles selected for the two streams which open into the mixing area. The principle of chaotic mixing is used in particular for mixing of viscous fluids at low speeds. In a known manner, chaotic mixing is based on “boulanger transform” for the mixing of the different layers of fluid. For example, according to one way of carrying out this transformation, the layers of fluid undergo passive division, then rotation in elbows with different chiralities, and finally recombination in order to obtain drawing and folding so as to assure homogeneous mixing.

In the invention, the mixing is not necessarily turbulent if the speed, or Reynolds number, does not exceed a certain threshold. The invention can thus permit mixing at a low speed or at a low Reynolds number, typically a Reynolds number Re lower than 2000, in particular between 100 and 1400. This is particularly advantageous when the device for thermal regulation is operating with speeds of streams of fluid which are insufficient to generate turbulent streams.

The invention makes it possible to mix the layers of fluid without generating excessive losses of load, in particular unlike turbulences which are sources of considerable losses of load.

According to one of the aspects of the invention, the angle of incidence between the two streams of fluid which open into the mixing area is between 45° and 90°, or between 70° and 90°. The angle can be equal to 90°.

According to one of the aspects of the invention, the circulation network comprises:
an area of separation of fluid which is designed to separate a stream of fluid into two separate streams;
the fluid mixing area, into which the separate streams of fluid open in order to permit the mixing.

Thus, thanks to separation of the flow of fluid then recombination of these flows of fluid, the invention makes it possible to mix the different layers of fluid in the mixing area.

It is understood that the mixing area is different from the area of separation.

According to one of the aspects of the invention, the openings are perpendicular to the general direction of the stream of fluid in the device.

According to one of the aspects of the invention, the channel and the mixing unit are designed to define at least one area of separation (51), and preferably at least two areas of separation, the at least one area of separation being designed to separate the stream of fluid into at least two separate flows, and, downstream, a mixing area in which the two separate flows mix.

According to one of the aspects of the invention, the separate flows have a parallel portion before rejoining in the mixing area.

According to one of the aspects of the invention, the angle of incidence between the two flows of fluid which open into the mixing area is between 45° and 90°, with the angle being defined in particular in relation to the axis z, i.e. the axis which intersects the 2 plates perpendicularly.

According to the invention, the flows which leave the separation area and regroup in the mixing area are conserved, in the sense that they do not receive any additional flows of fluid on this path between the area of separation and the mixing area.

According to one of the aspects of the invention, the sum of the transverse cross-sections of the flows which leave the mixing area separately is substantially equal to the cross-section of the mixing area.

According to one of the aspects of the invention, the area of separation comprises an obstacle placed in a channel of the circulation network, this obstacle being designed to separate the stream of fluid into two flows.

According to one of the aspects of the invention, the obstacle extends along the entire height of the channel.

According to one of the aspects of the invention, the obstacle is solid, i.e. the obstacle is different from a passage passing into the device for thermal regulation.

According to one of the aspects of the invention, the obstacle is of an intermittent type, i.e. with small dimensions in relation to the network for circulation of fluid as a whole. For example, the dimension of the obstacle is equal to at the most an inter-distance between two adjacent channels. This obstacle is not of the type with large dimensions, which would require several channels of the circulation network to follow bypass bends.

In the case of plates, the obstacle joins the two, lower and upper plates.

According to one of the aspects of the invention, the obstacle has a polygonal form, which in particular is substantially rectangular or in the form of a rhombus.

According to one of the aspects of the invention, the obstacle has dimensions and a form selected to create separate streams.

According to one of the aspects of the invention, the channel within which the obstacle is placed has lateral walls with a form selected to participate in the separation of the stream, and, downstream from the obstacle, in the recombination of the streams in the mixing area.

According to one of the aspects of the invention, the lateral walls of the channel each have an elbow, in particular with an angle of between 45° and 90°, in order to force the separate streams to follow bends, in particular with an angle of between 45° and 90°, around the obstacle.

According to one of the aspects of the invention, the angle of the elbow is equal to 90° or 45°, or has a value of between 90° and 45°.

According to one of the aspects of the invention, the device for thermal regulation comprises a plurality of channels side-by-side, in particular having symmetries by translation relative to one another, and each channel receives one or a plurality of obstacles in order to give rise to the separations and recombinations of streams of fluid.

According to one of the aspects of the invention, two adjacent channels share a common lateral wall.

According to one of the aspects of the invention, the network for circulation of fluid comprises a section of stream of fluid downstream from the mixing area, such that the fluid which flows in this section of stream of fluid has a relatively homogeneous temperature as a result of the mixing in the mixing area.

According to one of the aspects of the invention, the section of downstream stream has a transverse cross-section for the passage of fluid which is larger, for example by a factor of 2, than each of the transverse cross-sections of the separate streams of fluid.

For example, the obstacle has a width which is larger than a third or a half of the maximal transverse dimension of the downstream section.

As a variant, the obstacle has a width which is larger than the maximal transverse dimension of the downstream section.

Thus, these obstacles make it possible to create a separation into two flows, optionally into a laminar stream.

This is different from the prior art, which describes small obstacles (known as dimples) placed in the channels in order to create turbulence, without forming separate flows.

This is also different from the prior art, which proposes channels that separate into meanders from a fluid input in order to regroup just before reaching an output for the fluid outside the plates. On the contrary, in the present invention, the fluid which has undergone chaotic mixing, when the channels regroup is used to cool a region in which components to be cooled are located, and the fluid does not leave the device for thermal regulation without having provided useful thermal exchanges.

According to one of the aspects of the invention, the area of separation comprises two channels in which the stream divides into two flows.

According to one of the aspects of the invention, the circulation network comprises a plurality of elementary patterns, each formed by an area of separation of fluid and the mixing area which is associated with it.

According to one of the aspects of the invention, the elementary patterns are all identical, in particular aligned in parallel rows.

According to one of the aspects of the invention the pattern has a maximal dimension which is at least 20, 15, 10 or 5 times smaller than the maximal dimension of the network for circulation of fluid.

In other words, this pattern is relatively small compared with the circulation network as a whole. This pattern is used mainly to homogenize the temperature of the fluid, and not to act as a cooling interface with the components to be cooled. The network outside this pattern or these patterns plays this part of a cooling interface with the components.

According to one of the aspects of the invention, the distance between the centers of two successive patterns corresponds to the size of the pattern, with all of these dimensions being measured in the same direction.

According to one of the aspects of the invention, the network for circulation of fluid comprises a fluid stream section downstream from the mixing area, such that the fluid which flows in this fluid stream section has a relatively homogeneous temperature as a result of the mixing in the mixing area.

According to one of the aspects of the invention, the component to be cooled is placed in thermal contact with the section downstream from the mixing area.

Optionally, the component is not facing the mixing area. Thus, the component is cooled thanks to the contact with the section downstream from the mixing area.

According to one of the aspects of the invention, the length of the mixing area is shorter, in particular at least 2 times or 3 times or 5 times shorter than the length of the section of the stream of fluid downstream, with the length being measured between a fluid input and a fluid output of the mixing area respectively, of the section.

The separate streams are relatively close to one another. The spacing is selected mainly to permit an angular incidence of the flows to be mixed, in order to make efficient mixing possible. In the first instance, the spacing of the flows is not intended to cover smaller or larger surfaces to be cooled. The invention thus includes one or more mixing areas on a main fluid cooling path, which for example is globally straight, in order to homogenize the temperature of the fluid as well as possible within this main path.

According to one of the aspects of the invention, the separate streams of fluid which open into the mixing area are arranged on the same plane.

As a variant, the separate flows of fluid which open into the mixing area are arranged on different planes.

For example, the network for circulation of fluid extends on a main plane, and at least one of the separate streams extends, at least over a portion, outside this main plane.

For example, the device for thermal regulation comprises two channels for the separate flows, these channels extending on two distinct planes, for example two parallel planes, and, in particular, one of these channels comprises connection elbows on the other one of the channels. The heat-transfer fluid thus circulates from one plane to the other, and has at least one portion of stream which is for example perpendicular to these planes. When they join or recombine, the separate flows meet at an angle which allows them to be mixed, for example an angle substantially equal to 90°. In this example of the invention, the network for circulation of fluid uses directions of streaming in the three dimensions of space.

According to one of the aspects of the invention, there are exactly two separate flows which recombine in the mixing area.

According to one of the aspects of the invention, the circulation network is formed between a lower plate and an upper plate.

According to one of the aspects of the invention, one of the flows extends, at least over a portion, in a direction of the thickness between the two plates.

According to one of the aspects of the invention, at least one of the plates comprises regions in relief, in particular stamped regions, in order to form the channel(s) of the network and/or the fluid mixing area(s).

According to one of the aspects of the invention the plates both comprise regions in relief, in particular stamped regions, in order to form together the network for circulation of fluid, with the areas for mixing of fluid.

In another embodiment of the invention, the network for circulation of fluid comprises one or more tubes, within which the heat-transfer fluid circulates, and this tube or these tubes are designed to define the area(s) for mixing of the separate streams.

According to one of the aspects of the invention, this tube or these tubes comprise(s) obstacles for separation of the stream.

The invention also concerns an assembly comprising a component which can release heat during its operation, and a device for thermal regulation as described above, in contact with which the component is cooled.

According to one of the aspects of the invention, the heat-transfer fluid is a coolant fluid selected from among the coolant fluids R134a, R1234yf or R744. As a variant, the heat-transfer fluid is a glycoled water.

Other characteristics and advantages of the invention will become more clearly apparent from reading the following description provided by way of non-limiting illustration, and from the appended drawings in which:

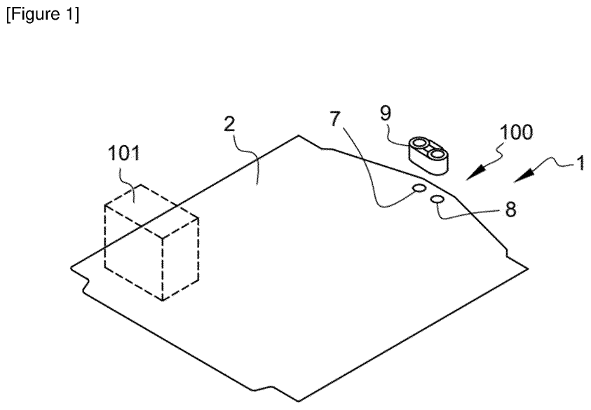

FIG. 1 illustrates, schematically and partly, a device for thermal regulation;

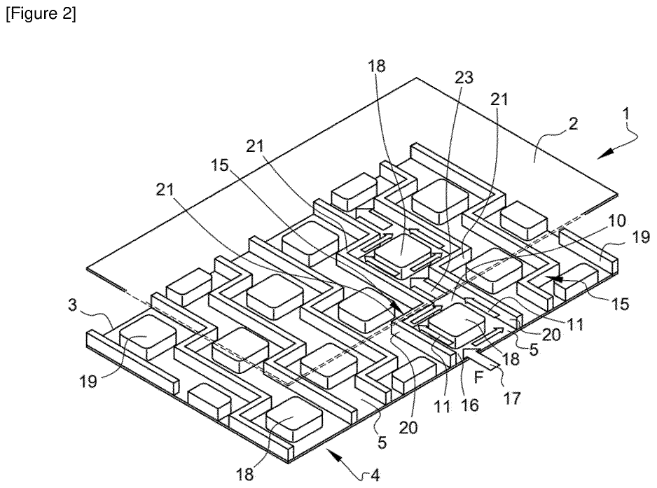

FIG. 2 illustrates, schematically and partly, the arrangement of the channels and the obstacles of a device for thermal regulation according to an embodiment of the invention;

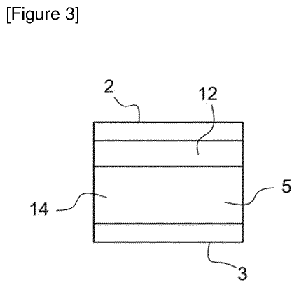

FIG. 3 illustrates, schematically and partly, a cross-section of a channel of FIG. 2;

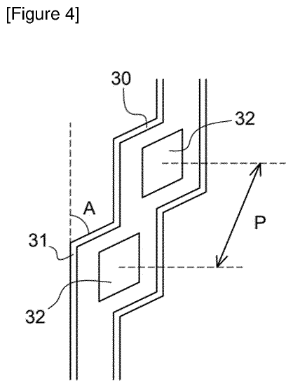

FIG. 4 illustrates, schematically and partly, a variant of the regulation device of FIG. 2;

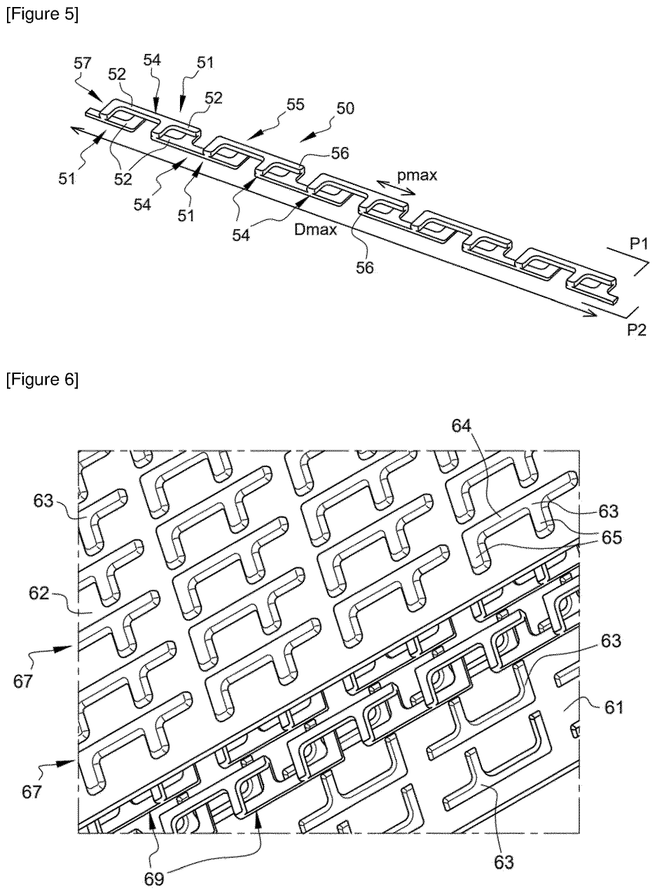

FIG. 5 illustrates, schematically and partly, another embodiment of the invention;

FIG. 6 illustrates, schematically and partly, another embodiment of the invention.

FIG. 1 represents an assembly 100 comprising a series of battery cells 101 to be cooled, which for example are positioned in a plurality of parallel rows, and a device for thermal regulation 1 designed to cool the cells 101, which are in thermal contact with an upper plate of the cooling device 1, as explained hereinafter.

The device for thermal regulation 1 comprises an upper plate 2 and a lower plate 3 assembled with the upper plate 2, in order to form together a circulation network 4 formed by a plurality of channels 5 for circulation of a liquid heat-transfer fluid, in particular a glycoled water, as shown better in FIG. 2.

The direction of circulation of the fluid in the channels 5 is shown by arrows F.

The channels 5 are supplied with fluid via a fluid distribution region, not represented, which communicates with a fluid input 7. A fluid output 8 is also provided. A flange 9 can be connected to this input 7 and this output 8, in order to assure connections with an external fluid circuit, which, inter alia, comprises a pump.

The circulation network 4 comprises areas 10 for mixing of fluid, into each of which two separate streams 11 of fluid open according to respective angles, selected such as to generate mixing of a parietal layer 12 of fluid and an internal layer 14 of fluid in the mixing area 10.

As illustrated highly schematically in FIG. 3, in the network 4 for circulation of heat-transfer fluid, a parietal layer 12 of fluid, which is on, or in the vicinity of, a heat-exchange wall 2, is heated more than the internal layer 14, which is further away from this wall 2. The internal layer 14 and the parietal layer 12 extend one another in a continuous manner in terms of temperature.

The temperature gradient within a transverse cross-section of fluid is greater upstream from the mixing area 10, and smaller in the mixing area 10. The mixing is intended to attenuate, or even eliminate, this temperature gradient within the fluid.

The invention thus makes it possible to homogenize the temperature of the fluid over all of the transverse cross-section of the stream, i.e. on the wall 2 and in the center of the stream.

The mixing can take place at relatively low speeds of the fluid, which mixing is of the chaotic type, thanks to the angles selected for the two streams which open into the mixing area.

In the example described, the angle of incidence between the two streams of fluid 11 which open into the mixing area 10 is 90°.

The circulation network 4 will now be described in greater detail.

The circulation network 4 comprises a plurality of elementary patterns 15 each formed by an area of separation of fluid 16 and the mixing area 10 which is associated with it.

The area of separation of fluid 16 is designed to separate a stream of fluid 17 into two separate streams 11.

The area for mixing of fluid 10 into which the separate streams 11 of fluid open permits the mixing.

Thanks to a separation of the flow of fluid, then recombination of these flows of fluid, this makes it possible to mix the different layers of fluid in the mixing area 10.

Each area of separation 16 is associated with a separator obstacle 18 placed in a channel 5 of the circulation network 4. The obstacle 18 is designed to separate the stream of fluid into two flows.

The obstacles 18 extend over the entire height of the channel 5.

Each obstacle 18 joins the two, lower 3 and upper 2 plates.

The lower plate 3 comprises stamped regions 19 which form the channels 5 of the network 4 and the obstacles 18 associated with the mixing areas 10.

In the example described in FIG. 2, the obstacle 18 has a rectangular form with rounded corners.

Each channel 5 within which the obstacles 18 are placed is delimited by lateral walls 20, with a form selected to participate in the separation of the stream, and, downstream from each obstacle 18, in the recombination of the streams 11 in the mixing area 10.

The lateral walls 20 of the channel have a succession of elbows 21 at 90°, in order to force the separate streams 11 to follow bends at 90°, around the obstacles 18.

The circulation network 4 comprises a plurality of channels 5 side-by-side, which are of symmetry by translation relative to one another, and each channel 5 receives a plurality of obstacles 18, in order to give rise to the separations and recombinations of streams of fluid, as can be seen in FIG. 2.

Two adjacent channels 5 share a common lateral wall 20.

The network 4 for circulation of fluid comprises a section of stream 23 of fluid downstream from each mixing area 10, such that the fluid which flows in this fluid stream section 23 has a relatively homogeneous temperature because of the mixing in the mixing area.

The downstream section of stream 23 has a transverse cross-section for the passage of fluid which is greater, for example by a factor of 2, than each of the transverse cross-sections of the separate streams of fluid 11.

In the example described, the obstacle 18 has a width which is greater than the width of the downstream section 23.

In a variant illustrated in FIG. 4, each channel 30 has elbows 31, which are no longer at a right-angle, but have an angle A smaller than 90°, for example 70°. The obstacles 32, which are identical, have the form of a rhombus, and are spaced from one another by a constant pitch P. In this example, the separate streams recombine with an angle of incidence A which is smaller than 90°, in order to limit the loss of load.

It should be noted that FIGS. 2 to 6 represent a succession of close areas of separation of fluid and mixing of fluid. These figures are schematic, and the pairs of areas of separation-mixing, also known as patterns, can be further apart from one another. In fact, the recombination advantageously permits better mixing than what is achieved conventionally in the prior art. This means that recombination of this type makes possible homogeneous mixing downstream, and makes it possible to space said patterns.

In another embodiment of the invention illustrated in FIG. 5, the network for circulation of fluid 50 comprises successive areas of separation 51 which each extend towards two distinct channels 52 in which the stream is divided into two flows. These channels 52 rejoin in mixing areas 54 in which the separate flows recombine.

Each area of separation 51, then the separate channels 52 and the mixing area 54, form an elementary pattern 55. The network for circulation of fluid 50 comprises a succession of such patterns 55, regularly spaced by a predetermined step.

Each pattern 55 has a maximal dimension pmax, in this case measured in the longitudinal direction, which is at least 20, 15, 10 or 5 times smaller than the maximal dimension Dmax of the network for circulation of fluid 50, also measured in the longitudinal direction. In the example described, there are ten patterns 55.

In the example described, certain separate streams of the channels 52 of fluid which open into the mixing area 54 are arranged on two different planes P1 and P2.

The network for circulation of fluid 50 generates stream bends 56 which go from one plane P1 or P2 to the other.

The heat-transfer fluid thus circulates from one plane P1 or P2 to the other. When they join or recombine, the separate flows meet according to an angle which allows them to be mixed, in this case an angle substantially equal to 90°. The circulation network 50 uses directions of stream in the three dimensions of space.

In this embodiment of the invention, the network for circulation of fluid comprises tubes 57 within which the heat-transfer fluid circulates, and these tubes are designed to define the areas of mixing 54 of the separate streams.

FIG. 6 represents another embodiment of the invention.

In this example, the device for thermal regulation comprises two plates 61 and 62 which have regions in relief 63, in this case stamped regions, in order to form together the network for circulation of fluid, with the areas for mixing of fluid. Each relief 63 has a pattern with a longitudinal branch 64 to which two transverse branches 65 are connected. The passage is repeated in parallel rows 67 on each of the plates 61 and 62. The patterns of one of the plates 61, 62 are in mirror symmetry with the patterns of the other plates 61, 62, and are offset from one plate to another by a predetermined step.

A network of fluid, designated by the reference arrow 69, is thus formed between these plates 61 and 62.

FIG. 6 shows firstly the two plates 61 and 62 not yet assembled, and secondly the network of fluid 69 which will be obtained.

The network for circulation of fluid obtained in the present example is substantially analogous to that 50 described in the example in FIG. 5, which uses streams in the three dimensions of space.

1. A device for thermal regulation for a component which can release heat during its operation, the device comprises a circulation network for a heat-transfer fluid, wherein the circulation network comprises at least one area for mixing of fluid into which at least two separate streams of fluid open according to respective angles selected to generate a mixture of a parietal layer of fluid and an internal layer of fluid in the mixing area.

2. The device as claimed in claim 1, wherein the angle of incidence between the two streams of fluid which open into the mixing area is between 45° and 90°.

3. The device as claimed in claim 1, wherein the circulation network further comprising:
an area of separation of fluid which is designed to separate a stream of fluid into two separate streams; and
the mixing area, into which the separate streams of fluid open in order to permit the mixing.

4. The device as claimed in claim 3, wherein the area of separation comprises an obstacle placed in a channel of the circulation network, wherein the obstacle is designed to separate the stream of fluid into two flows.

5. The device as claimed in claim 4, wherein the obstacle extends along an entire height of the channel, wherein the obstacle having a polygonal form, which is substantially rectangular.

6. The device as claimed in claim 4, wherein the channel within which the obstacle is placed has lateral walls with a form selected to participate in the separation of the stream, and, downstream from the obstacle, in a joining of the separate streams in the mixing area.

7. The device as claimed in claim 6, wherein the lateral walls of the channel each have an elbow, with an angle of between 45° and 90°, in order to force the separate streams to follow bends, with an angle of between 45° and 90°, around the obstacle.

8. The device as claimed in claim 1, wherein the network for circulation of fluid comprises a section of stream of fluid downstream from the mixing area, such that the fluid which flows in this section of stream of fluid has a relatively homogeneous temperature as a result of the mixing in the mixing area, and the section of stream has a transverse cross-section for a passage of fluid which is larger than each of the transverse cross-sections of the separate streams of fluid.

9. The device as claimed in claim 1, wherein the circulation network comprises a plurality of elementary patterns, each formed by an area of separation of fluid and the mixing area which is associated with it.

10. The device as claimed in claim 1, wherein separate flows of fluid which open into the mixing area are arranged on different planes.

11. The device as claimed in claim 1, wherein the circulation network is formed between a lower plate and an upper plate.

12. The device as claimed in claim 11, wherein at least one of the plates comprises regions in relief, in order to form a channel(s) of the circulation network and/or the mixing area(s).

13. The device as claimed in claim 1, wherein the network for circulation of fluid comprises one or more tubes, within which the heat-transfer fluid circulates, and this tube or these tubes are designed to define the area(s) for mixing of the separate streams.

14. An assembly comprising a component which can release heat during its operation, and the device for thermal regulation as claimed in claim 1, in contact with which the component is cooled.
